(19) United States
(12) Patent Application Publication
(10) Pub. No.: US 2004/0220772 A1
(43) Pub. Date: Nov. 4, 2004

(54) Method and system for authoring case bases related to work machines

(76) Inventors: Tara L. Cobble, Stamford (GB); Shannon S. Duvendack, East Peoria, IL (US); Arun Karumanchi, Cary, NC (US); Robert A. Peterson, Morton, IL (US); James E. Wagner, Chillicothe, IL (US)

Correspondence Address: CATERPILLAR INC., 100 N.E. ADAMS STREET, PATENT DEPT., PEORIA, IL, 616296490

(21) Appl. No.: 09/745,228

(22) Filed: Dec. 20, 2000

(51) Int. Cl. G06F 9/44

(52) U.S. Cl. 702/183

(57) ABSTRACT

A computer based system and method for authoring case bases related to a work machine is provided. The case bases is comprised of diagnostic information and processes related to the work machine. As a function of input from an author, a case base is authored. An external source containing service information related to the work machine is provided. As a function of input from the author, links are provided within the case base to related information contained in the external source.

### TECHNICAL FIELD

This invention relates generally to providing diagnostics for work machines and work particular to a method and system for authoring case bases for work machines.

### BACKGROUND ART

Case based reasoning has been applied to various diagnostics and “help-desk” tools. A case contains a list of symptoms, a set of case bases and a set of action items describing an appropriate repair or test. A case base contains questions and paths to possible repairs/tests, i.e., action items.

An author creates/writes “questions” and “answers” which are designed to lead the user to a diagnosis or an action item to solve the problem.

However, for some work machines or systems there are in existence other tools and systems containing information related to the machine, e.g., repair and technical information. In the field, there may be other systems directly connected to the machine or system that contain information which would be helpful to the diagnostic system to have access to assist in the process of diagnosing or providing repair or test solutions.

The present invention is directed to overcome one or more of the problems as set forth above.

### DISCLOSURE OF THE INVENTION

In one aspect of this invention, a computer based method for authoring case bases related to a work machine is provided. The case bases is comprised of diagnostic information and processes related to the work machine. The method includes the steps of, as a function of input from an author, authoring a case base, providing an external source containing service information related to the work machine, and, as a function of input from the author, providing a link within the case base to related information contained in the external source.

In another aspect of the present invention, a computer based system for authoring case bases related to a work machine is provided. The system includes an external source and a diagnostic reasoning authoring tool. The external source contains service information related to the work machine The diagnostic reasoning authoring tool is used for authoring a case base. The diagnostic reasoning authoring tool contains an attachment utility for providing a link, based on input from an author, to related information in the external source.

### BRIEF DESCRIPTION OF THE DRAWINGS

FIG. 1 is a block diagram of a computer based system for authoring cases related to work machines, according to an embodiment of the present invention;

FIG. 2 is a flow diagram of a method for authoring cases related to work machines, according to an embodiment of the present invention;

FIG. 3 is a diagrammatic illustration of a Logon Information Window of the computer based system and method of FIGS. 1 and 2;

FIG. 4 is a diagrammatic illustration of a Logon Error Window of the computer based system and method of FIGS. 1 and 2;

FIG. 5 is a diagrammatic illustration of a Main Utility Menu of the computer based system and method of FIGS. 1 and 2;

FIG. 6 is a diagrammatic illustration of a Attachment Utility screen of the computer based system and method of FIGS. 1 and 2;

FIG. 7 is a diagrammatic illustration of a Find Serial Number Prefix Dialog of the computer based system and method of FIGS. 1 and 2;

FIG. 8 is a diagrammatic illustration of a Serial Number Invalid Warning Dialog of the computer based system and method of FIGS. 1 and 2;

FIG. 9 is a diagrammatic illustration of an Alert Message Dialog of the computer based system and method of FIGS. 1 and 2;

FIG. 10 is a diagrammatic illustration of an Alert Dialog of the computer based system and method of FIGS. 1 and 2;

FIG. 11 is a diagrammatic illustration of a DAT Test Proc Panel of the computer based system and method of FIGS. 1 and 2;

FIG. 12 is a diagrammatic illustration of as SMCS Panel of the computer based system and method of FIGS. 1 and 2;

FIG. 13 is a diagrammatic illustration of a DPSO Panel of the computer based system and method of FIGS. 1 and 2;

FIG. 14 is a diagrammatic illustration of a Configuration Dialog of the computer based system and method of FIGS. 1 and 2;

FIG. 15 is a diagrammatic illustration of a Diag Codes Tool Call Panel of the computer based system and method of FIGS. 1 and 2;

FIG. 16 is a diagrammatic illustration of a Status Tool Call Panel of the computer based system and method of FIGS. 1 and 2;

FIG. 17 is a diagrammatic illustration of an Execute Tools Calls Tab of the computer based system and method of FIGS. 1 and 2;

FIG. 18 is a diagrammatic illustration of a Serial Number Effectivity Screen of the computer based system and method of FIGS. 1 and 2;

FIG. 19 is a diagrammatic illustration of a View Menu of the computer based system and method of FIGS. 1 and 2;

FIG. 20 is a diagrammatic illustration of a Case View Links Screen of the computer based system and method of FIGS. 1 and 2;

FIG. 21 is a diagrammatic illustration of a Case View Screen of the computer based system and method of FIGS. 1 and 2;

FIG. 22 is a diagrammatic illustration of a Case Base Dialog of the computer based system and method of FIGS. 1 and 2;

FIG. 23 is a diagrammatic illustration of a Serial Number Publish Dialog of the computer based system and method of FIGS. 1 and 2;

FIG. 24 is a diagrammatic illustration of a Publish Confirmation Dialog of the computer based system and method of FIGS. 1 and 2;

FIG. 25 is a diagrammatic illustration of an Add Effectivity Dialog of the computer based system and method of FIGS. 1 and 2;

FIG. 26 is a diagrammatic illustration of an Update Effectivity Dialog of the computer based system and method of FIGS. 1 and 2;

FIG. 27 is a diagrammatic illustration of a User Properties Screen of the computer based system and method of FIGS. 1 and 2;

FIG. 28 is a diagrammatic illustration of an Add User Dialog of the computer based system and method of FIGS. 1 and 2;

FIG. 29A is a flow diagram of a first portion of an authoring process, according to an embodiment of the present invention; and,

FIG. 29B is a flow diagram of a second portion of the authoring process of FIG. 29A.

### BEST MODE FOR CARRYING OUT THE INVENTION

With reference to the drawings and in operation, the present invention provides a computer based method and system and a computer program for authoring cases related to a work machine 128. The work machine 128 can be any sort of machine such as an earthmoving machine, construction machine, transportation machine, engine, computer, air conditioner, etc. . . . This list is exemplary only and not intended to be exclusive.

Generally, a case contains diagnostic information and processes related to a work machine 128. A case contains a list of symptoms, a set of case bases, and a set of action items describing an appropriate repair or test. A case base contains questions and paths to possible repairs/tests.

Preferably, the present invention is implemented in software for execution on computers connected in a network.

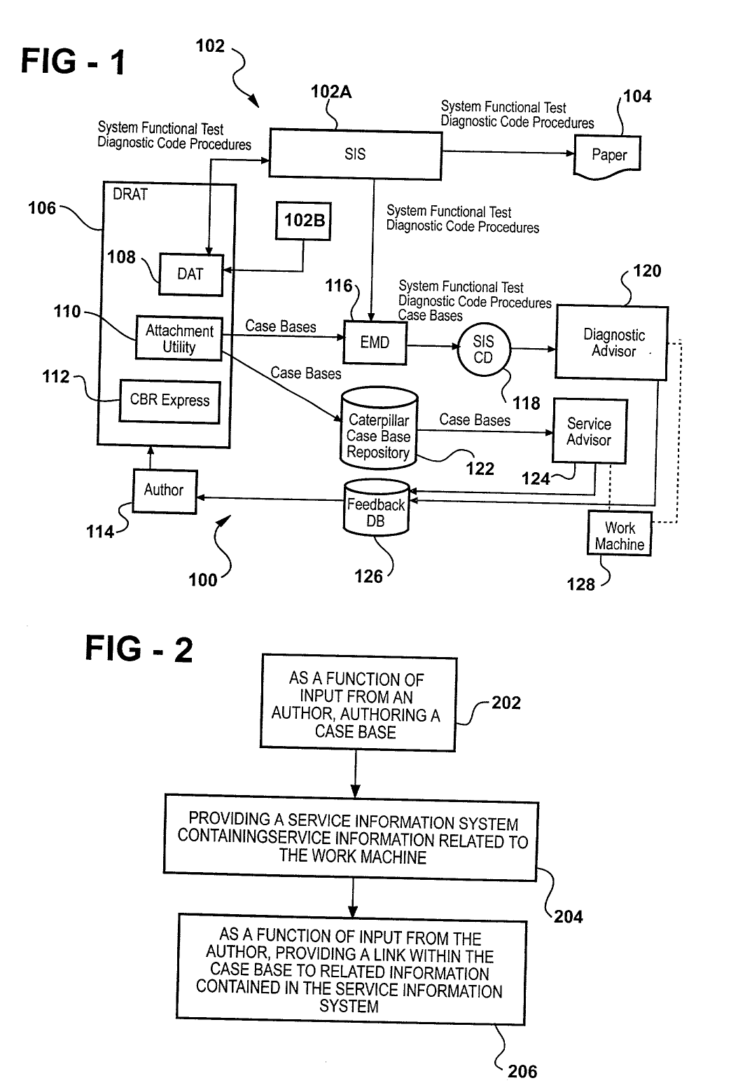

With reference to FIG. 1, a computer based system 100 for authoring case bases related to a work machine 128 according to the present invention will now be discussed.

A service information system 102A includes service information related to the work machine 128. Preferably, the service information system 102A includes system functional tests and diagnostic code procedures which are published in paper format (indicated by reference number 104), but may be published on electronic media.

The computer based system 100 includes a diagnostic reasoning authoring tool (DRAT) 106 for authoring case bases (as discussed below). In the preferred embodiment, the DRAT 106 includes a diagnostic authoring tool 108, an attachment utility 110 and a case base authoring tool 112.

The computer based system 100 is utilized by an author 114. The author 114 may be one person or several persons having specified roles within the case authoring process (as discussed below).

The diagnostic authoring tool 108 allows the author 114 to author at least one system functional test and/or at least one diagnostic code procedure. A system functional test is defined as a procedure for troubleshooting systems, circuits or specific components of the work machine 128. Most of these tests are developed to determine if the system, circuit or component is functioning correctly, and if not, to isolate the cause of the problem. A diagnostic code procedure is defined as trouble shooting procedures for determining the cause of a diagnostic code returned by an electronic control module (ECM) over a data link identifying past or present logged problems with the ECM (not shown).

The attachment utility 110 is coupled to the an external source 102, i.e., the service information system 102A and or other source on the computer network including a local hard drive 102B, and allows the author 114 to insert links into a case base to related information from the external source 102.

The case base authoring tool 112 is used by the author 114 to write the diagnostic cases and case bases for the work machine 128. Preferably, the case base authoring tool 112 is comprised of a commercially available software tool licensed by eGain Communications Corp., having an office at 455 W. Maude Ave., Sunnyvale, Calif. 94086. under the name CBR Express. Each case may include one or more recommended repairs. A recommended repair includes a description of the repair and with links to the external source 102 for additional information to guide the repair.

The system 100 includes an electronic media delivery system 116 for delivering the case base electronically for publication. The electronic media delivery system 116 is adapted to publish the case base (or one or more cases each containing a multitude of case bases) on computer readable media and/or on-line.

Preferably, the electronic media delivery system 116 publishes the case(s) and information from the service information system 102A on an electronic media, e.g., compact disc 118. The electronic media 118 is utilized by a diagnostic delivery system 120 to perform diagnostics on the work machine 128 in the field. Preferably, updated electronic media 118 are released on a periodic basis, e.g., monthly. The diagnostic delivery system 120 may be accessed by a workstation (not shown) at a dealership or via a laptop (not shown) by a technician in the field.

The case base authoring tool 112 provides the search engine to search on the symptoms described by the user of the diagnostic delivery system 120 and returns questions to the user to further refine the search. As a result of this consultation, the relevant solutions will emerge with the highest scores (relevancy). The user will continue answering questions and performing actions until the root cause of the problem has been identified and an appropriate action is taken to correct the problem.

The case bases are also stored in a case base repository 122 for access by a service advisor 124, such as a help desk. Users of the diagnostic delivery system 120 and the service advisor 124 may provide feedback regarding the case bases to a feedback database 126. The author 114 has access to the feedback database 126 for possible incorporation of the feedback into future case bases.

As stated above, the computer based system 100 is embodied in computer program product i.e., software. The computer program product comprises a computer usable storage medium having computer readable program code means embodied in the medium.

With reference to FIG. 2, a computer based method 200 for authoring case bases related to a work machine 128 according to the present invention is provided. In a first step 202, a case base is authored as a function of input from the author 114. In a second step 204, a service information system containing service information related to the work machine 128 is provided. In a third step 206, a link is provided within the case base to related information contained in the service information system.

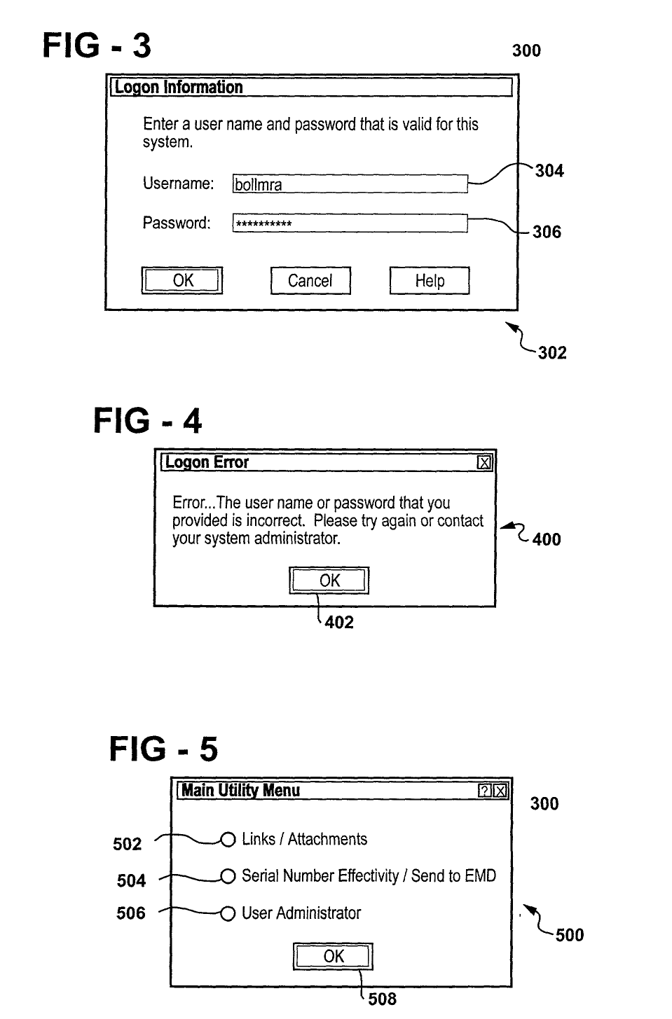

With reference to FIGS. 3-17, the present invention provides a graphical user interface 300 for use by the author 114 to interface with the system 100.

With specific reference to FIG. 3, a Logon Information Window 302 used to gain access to the computer based system 100. The Logon Information Window 302 includes a User Name Text Field 304 and a Password Text Field 306. The user or author enters their information in the User Name Text Field 304 and Password Text Field 306.

With reference to FIG. 4, if the data entered in the Logon Information Window 300 is not correct then the user will proceed to a Logon Error Window 400 with an OK Button 402 indicating that the data was not correct. Actuation of the OK Button 402 returns the user to the Logon Information Window 300.

With reference to FIG. 5, if the data entered in the Logon Information Window 300 is correct then a Main Utility Menu 500 is presented. The Main Utility Menu 500 includes a Links/Attachment Radio Button 502, a Serial Number Effectivity//Send to EMD Radio Button 504, a User Administration Radio Button 506, and an OK Button 508.

Only one of the Radio Buttons 502, 504, 506 may be actuated at any one time. The user selects a Radio Button 502, 504, 506 according to the functions that the user wants to perform and then actuates the OK Button 508. One or more of the Radio Buttons 502, 504, 506 may be de-activated based on the user's status.

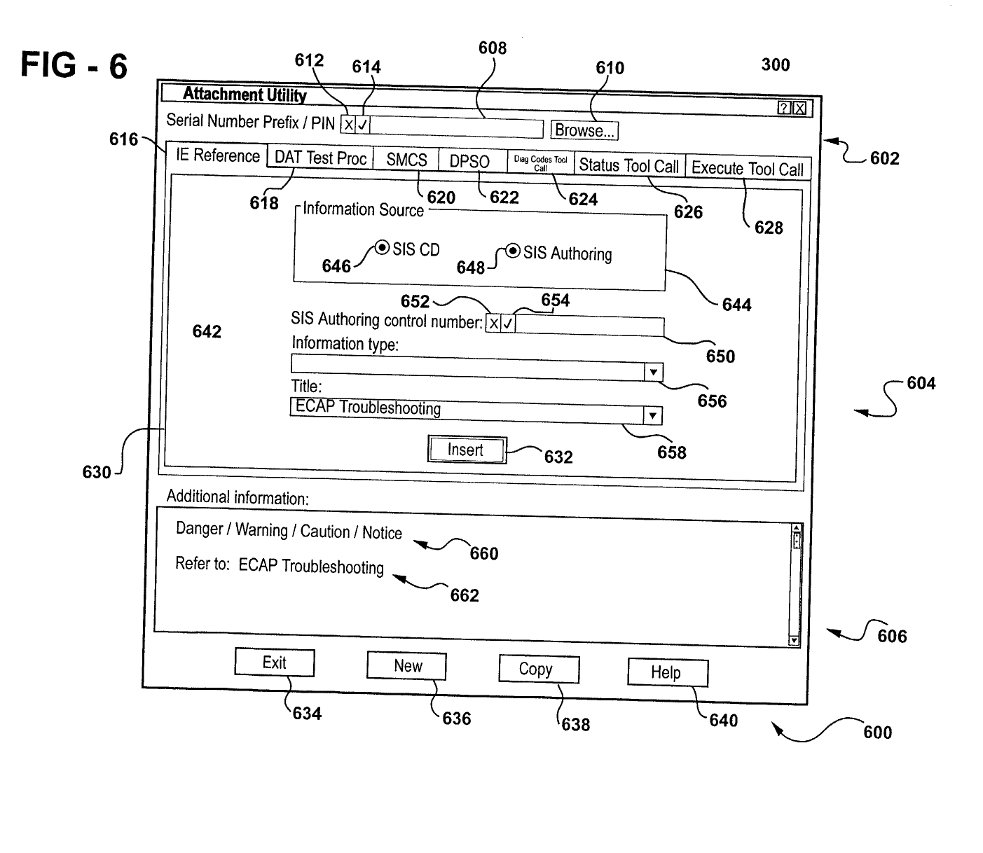

With reference to FIG. 6, upon actuation of the OK button 508 in the Main Utility Menu 500 with the Links/Attachment Radio Button 502 selected, an Attachment Utility Screen 600 is displayed.

The Attachment Utility Screen 600 is used to enter descriptive text for inserted references and links in the cases. The Attachment Utility Screen 600 includes Serial Number Lookup Section 602, an Attachment Tabbed Window Pane 604, and an Additional Information Text Box 606.

When the Attachment Utility Screen 600 is initialized, only the Serial Number Lookup Section 602 is enabled. The Serial Number Lookup Section 602 includes a Serial Number Text Box 608 and a Serial Number Browse Button 610.

The user may enter the Serial Number for the desired work machine 128 directly in the Serial Number Text Box 608 or activate the Serial Number Browse Button 610.

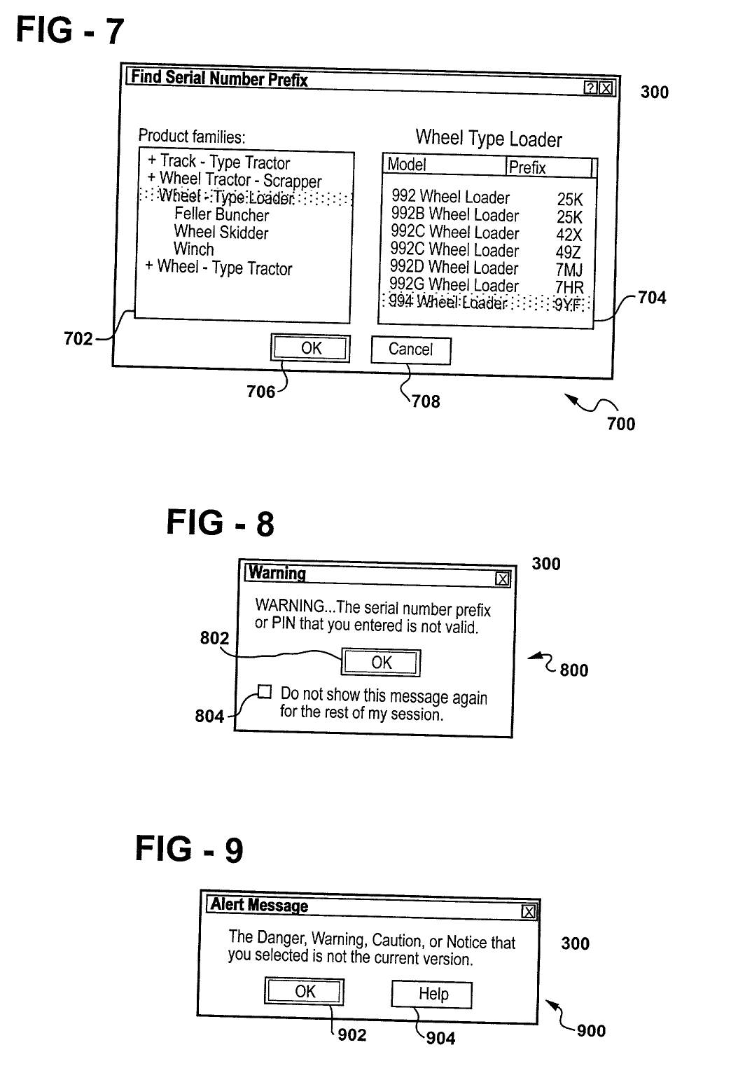

With reference to FIG. 7, if the user activates the Serial Number Browse Button 610, then a Find Serial Number Prefix Dialog 700 is displayed. The Find Serial Number Prefix Dialog 700 includes a Product Family List 702 and a Model List 704. The Product Family List 702 includes an expandable list of all product families available. When the user selects a product family from the Product Family List 702, the product models and serial number prefixes for the select family are displayed in the Model List 704. The Find Serial Number Prefix Dialog 700 includes an OK Button 706 and a Cancel Button 708.

After a product family and model have been selected in the Product Family List 702 and the Model List 704, respectively, the OK Button 706 is activated. If the user actuates the OK Button 706, the selected serial number prefix is entered into the Serial Number Text Box 608. If the user actuates the Cancel Button 708, then the Find Serial Number Prefix Dialog 700 is erased or dismissed.

The Serial Number Lookup Section 602 includes a New Button 612 and a Clear Button 614. If the user actuates the New Button 612, the Serial Number Text Box 608 is cleared.

After the user has entered a prefix, the user may either actuate the Check Button 614 or the <ENTER> key on a keyboard (not shown).

With reference to FIG. 8, a Serial Number Invalid Warning Dialog 800 is displayed indicating that the Serial Number is invalid. The Serial Number Invalid Warning Dialog 800 includes an OK Button 802 and a Check Box 804. Preferably, the attachment utility 110 allows the user to attach links for a serial number not currently in the database. The user can actuate the Check Box 804 to disable the Serial Number Invalid Warning Dialog 800 for the remainder of the current session. The user must actuate the OK Button 802 to return to the Attachment Utility Screen 600.

After a serial number has been entered into the Serial Number Lookup Section 602, the Attachment Tabbed Window Pane 604 becomes active. The Attachment Utility Screen 600 allows the user to attach links to several different types of information. Preferably, these types are IE References, DAT Test Procedures, SMCS, DPSO, Diagnostic Codes Tool Calls, Status Call Tools and Execute Tool Calls. Accordingly, the Attachment Tabbed Window Pane 604 includes an IE References Tab 616, a DAT Test Procedures Tab 618, an SMCS Tab 620, a DPSO Tab 622, a Diagnostic Codes Tool Calls Tab 624, a Status Call Tools Tab 626 and an Execute Tool Calls Tab 628. The Attachment Tabbed Window Pane 604 also includes an Attachment Information Panel 630 which contains information relative to the selected Tab 616, 618, 620, 622, 624, 626, 628.

To enter a link of a particular type, the user selects the appropriate Tab 616, 618, 620, 622, 624, 626, 628. As discussed below, the contents of the Attachment Information Panel 630 are a function of the selected Tab 616, 618, 620, 622, 624, 626, 628.

The Attachment Information Panel 630 includes an Insert Button 632. After the user enters information in the Attachment Information Panel 630, the user actuates the Insert Button 632 to insert a link using the entered information into the Additional Information Text Box 606. After the user actuates the Insert Button 632, the Attachment Information Panel 630 is reset to its initial state.

The Attachment Utility Screen 600 further includes an Exit Button 634, a New Button 636, a Copy Button 638 and a Help Button 640. Actuation of the Exit Button 634 dismisses the Attachment Utility Screen 600. Actuation of the New Button 636 clears the Attachment Information Panel 630.

If the Exit Button 634 or the New Button 636 is actuated while there is information in the Attachment Information Panel 630 then a Warning Dialog (not shown) is displayed.

Once a link has been selected and inserted in the Attachment Tabbed Window Pane 604, a link appears in the Additional Information Text Box 606. The Additional Information Text Box 606 is a representation of what will be seen on the delivery side, e.g., in the Diagnostic Delivery System 120 and the Service Advisor 124. The user may type and edit descriptive text of the link.

As shown in FIG. 6, when the IE Reference Tab 616 has been selected, an IE Reference Panel 642 is displayed in the Attachment Information Panel 630. The Attachment Information Panel 630 is used to create a link to an information source from the Service Information 102. The Attachment Information Panel 630 is also used to create Dangers, Warnings, Cautions, and Notices, collectively, Alerts.

The Attachment Information Panel 630 includes an Information Source Section 644 with a SIS CD Radio Button 646 and a SIS Authoring Radio Button 648. The Information Source Section 644 defines the source of the linked information—either electronic media, i.e., a SIS compact disc or the SIS Authoring Software module (not shown). The SIS CD and SIS Authoring Radio Buttons 646, 648 are mutually exclusive. The Attachment Information Panel 630 further includes a SIS Authoring Control Number Text Box 650. The user enters the control number for the desired information element into the Text Box 650. A SIS Clear Button 652 and a SIS Check Button 654 allow the user to clear or select the Text Box 650. An Information Type Drop Down List 656 allows the user to select the type of link being inserted. A Title Drop Down List 658 allows the user to select a title for the link. The list of available titles is dependent upon the control number entered in to the SIS Authoring Control Number Text Box 650 and the Information Type Drop Down List 656.

After all information has been entered, the user actuates the Insert Button 632 to insert the link into the Additional Information Text Box 606.

When more than one Alert is inserted into the Additional Information Text Box 606, a single Alert Link 660 (as shown) will be inserted. The title of the link will have the type of the alerts that have been inserted, i.e., danger, warning, caution and/or notice.

An exemplary link 662 to information contained in the Service Information System 102 is also shown.

With reference to FIG. 9, if the user enters a control number for an out of date Alert, then an Alert Message Dialog 900 will be displayed. The Alert Message Dialog 900 includes an OK Button 902 and a Help Button 904. The OK Button 902 must be actuated to dismiss the Alert Message Dialog 900.

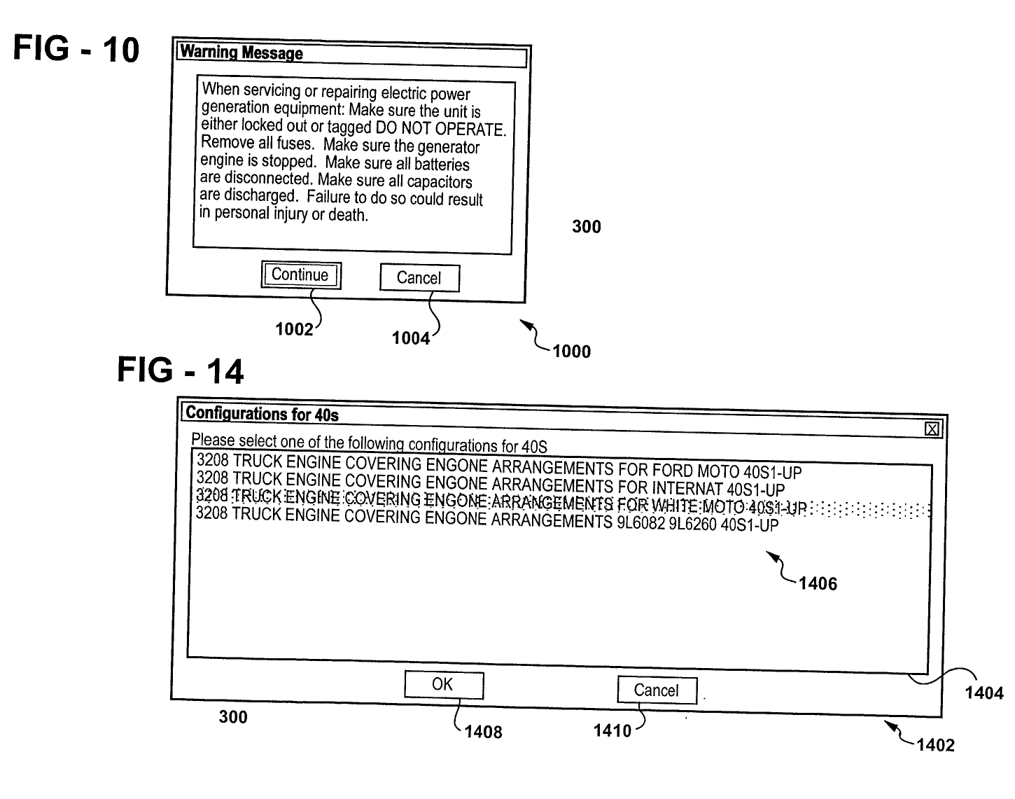

With reference to FIG. 10, when the Insert Button 632 is actuated to insert an Alert, an Alert Dialog 1000 is displayed. The Alert Dialog 1002 illustrates what will appear with the insert link. The title of the Alert Dialog 1000 is a function of the type of Alert. If the user agrees with the Alert Dialog, then a Continue Button 1002 must be actuated. To change information in the IE Reference Panel 642 without inserting the link, a Cancel Button 1004 must be actuated.

If an Alert is mistakenly inserted, the user must delete the Alert from within the Case Base Authoring Tool 112. Alerts will always appear at the top of all links currently in the Additional Information Text Box 606. The user may double-click on any link within the Additional Information Text Box 606 to see how the link will be displayed within the Diagnostic Delivery System 120 or the Service Advisor 124.

Actuation of the Copy Button 636 copies the contents of the Additional Information Text Box 606 to a clipboard (not shown). Information in the clipboard can then be copied within the system 100 or to other applications.

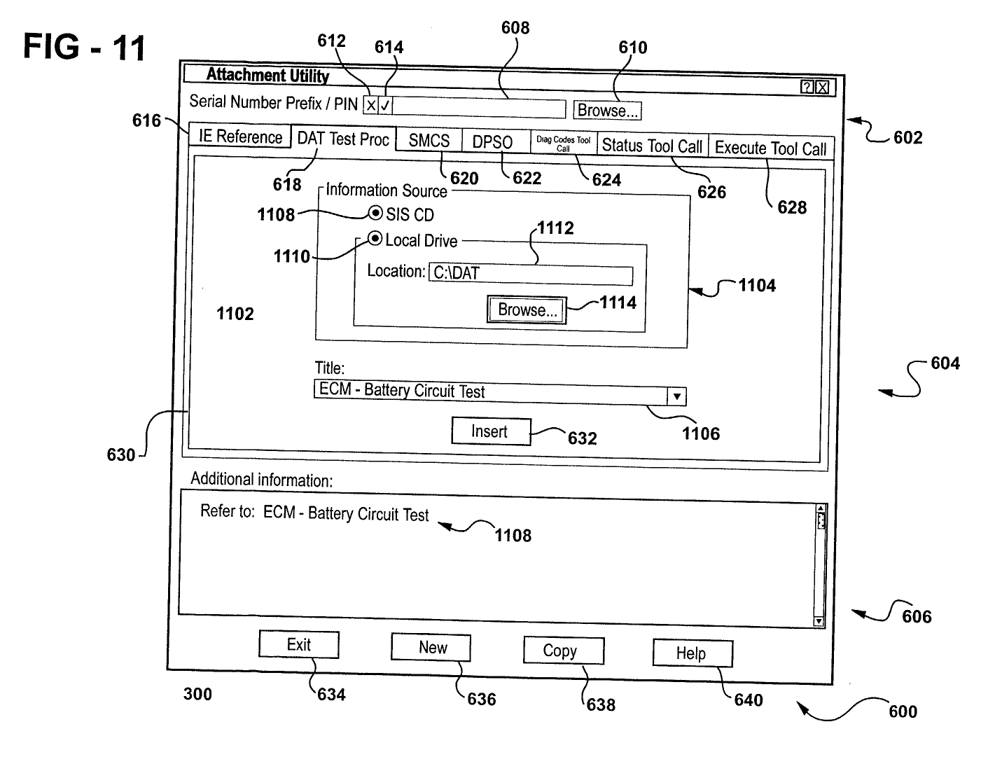

With reference to FIG. 11, upon user selection of the DAT Test Proc Tab 618, a DAT Test Proc Panel 1102 is displayed in the Attachment Information Panel 630. The DAT Test Proc Panel 1102 allows the user to create a link to a DAT Test Proc. A DAT Test Proc is either a system functional test or a diagnostic code procedure.

The DAT Test Proc Panel 1102 includes a DAT Information Source Section 1104 and a DAT Title Drop Down List 1106. The DAT Information Source Section 1104 includes a SIS CD Radio Button 1108 and a Local Drive Radio Button 1110. The user must select either Radio Button 1108, 1110 to select the source for the desired link. A DAT Location Text Box 1112 and a Browse Button 1114 allow the user to select the location, i.e., directory, for the source of the link.

The Drop Down List 1106 is used to select a title from a list of available DAT Test Proc.'s located at the indicated source. An exemplary link 1108 is shown in the Additional Information Text Box 606.

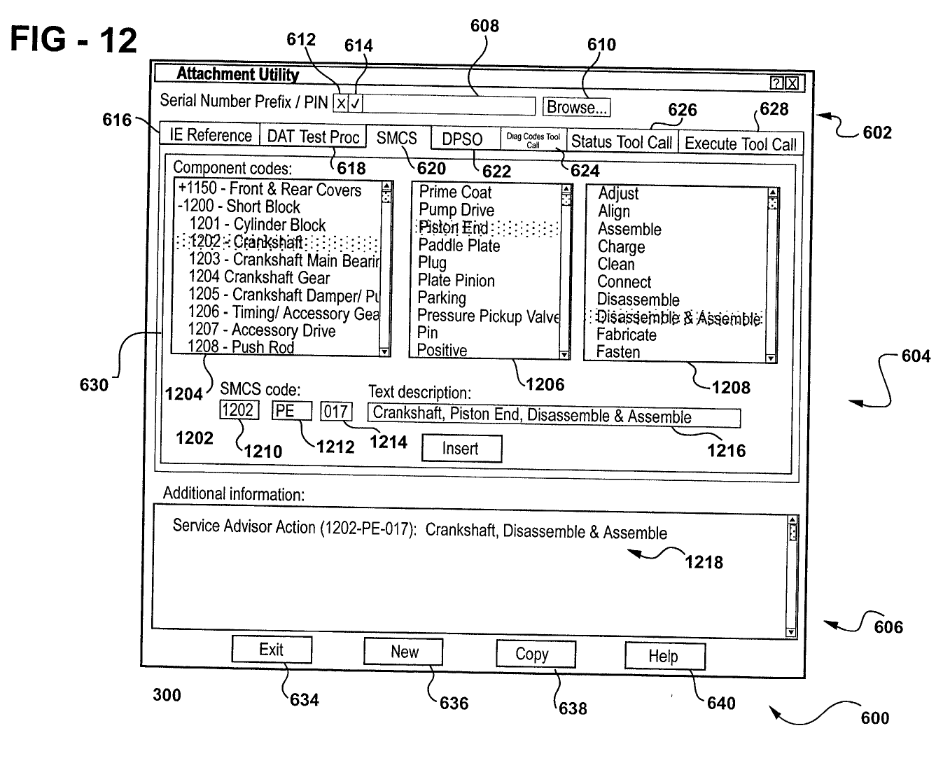

With reference to FIG. 12, upon user selection of the SMCS Tab 620, a SMCS Panel 1202 is displayed in the Attachment Information Panel 630. The SMCS Panel 1202 allows the user to create a link to standard job data which will be used by the Service Advisor 124.

The SMCS Panel 1202 includes an expandable Component List 1204, a Modifier Code List 1206, and a Job Code List 1208. The user must select a component code and a job code from the Component List 1204 and the Job Code List 1208, respectively. Selection of a modifier code from the Modifier Code List 1206 is optional. As the user makes selections from the Component List 1204, Modifier Code List 1206 and Job Code List 1208, the respective codes are displayed in a Component Text Box 1210, a Modifier Text Box 1212, and a Job Code List 1214, respectively. Alternately, the user may enter the codes in the Text Boxes 1210, 1212, 1214 directly. Descriptive text based on the selected codes is displayed in a read-only Descriptive Text Box 1216.

Actuation of the Insert Button 632 enters a link 1218 into the Additional Information Text Box 606, as shown. As described above, the user can add additional descriptive text to the link 1218 in the Additional Information Text Box 606.

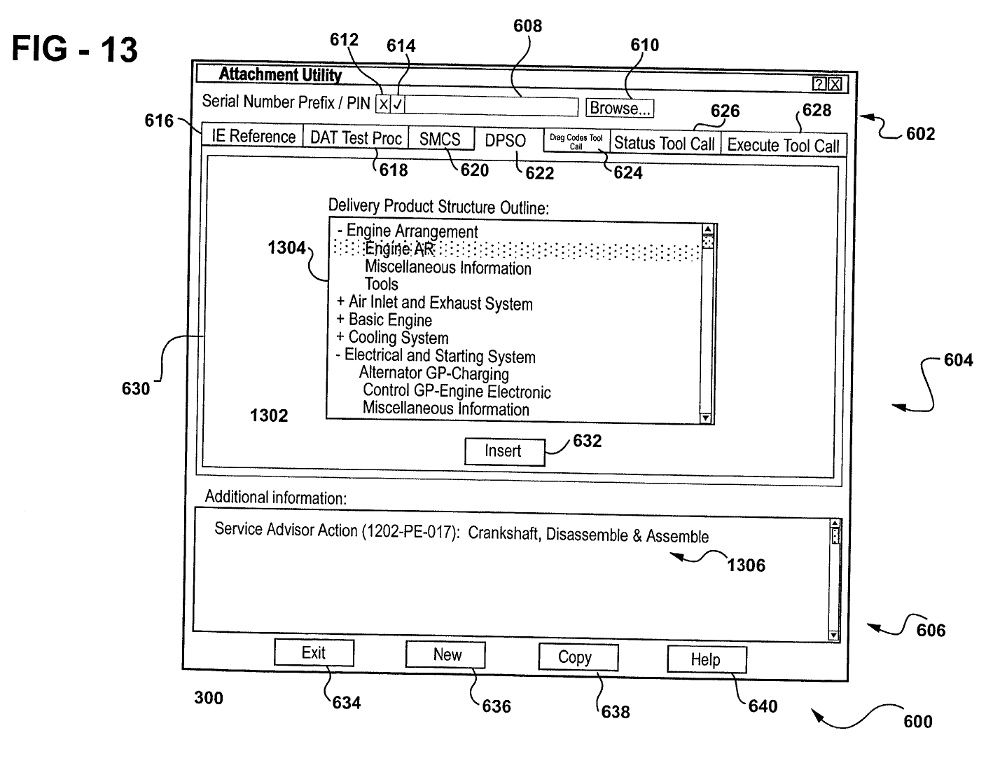

With reference to FIG. 13, upon user selection of the DPSO Tab 622, a DPSO Panel 1302 is displayed in the Attachment Information Panel 630. The DPSO Panel 1202 allows the user to create a link to a Delivery Product Structure Outline. A Delivery Product Structure Outline is defined as a numerical value that identifies a technical document relating to a particular area, component, or product, i.e., work machine.

The DPSO Panel 1202 includes an expandable Delivery Product Structure Outline List 1304. The Delivery Product Structure Outline List 1304 fills with all of the data in a compressed format. The user can, for example, single click on a plus sign or double click on the words to have the DPSO description expand. When the insert button 632 is actuated, a link 1306 to the selected DPSO is inserted into the Additional Information Text Box 606. As described above, the user can add additional descriptive text to the link 1306 in the Additional Information Text Box 606.

With reference to FIG. 14, if multiple configurations exist for the selected DPSO, then a Configuration Dialog 1402 is displayed. The Configuration Dialog 1402 includes a Configuration List 1404. A list 1406 of the possible configurations for the selected DPSO is shown. The Configuration Dialog 1402 includes a OK Button 1408 and a Cancel Button 1410. Once a configuration is selected, the OK Button 1408 is activated. If the OK Button 1408 is actuated, then the selected configuration is used. If the Cancel Button 1410 is actuated, then the Configuration Dialog 1402 is dismissed and control returns to the Attachment Utility Screen 600 without a link being added to the Additional Information Text Box 606.

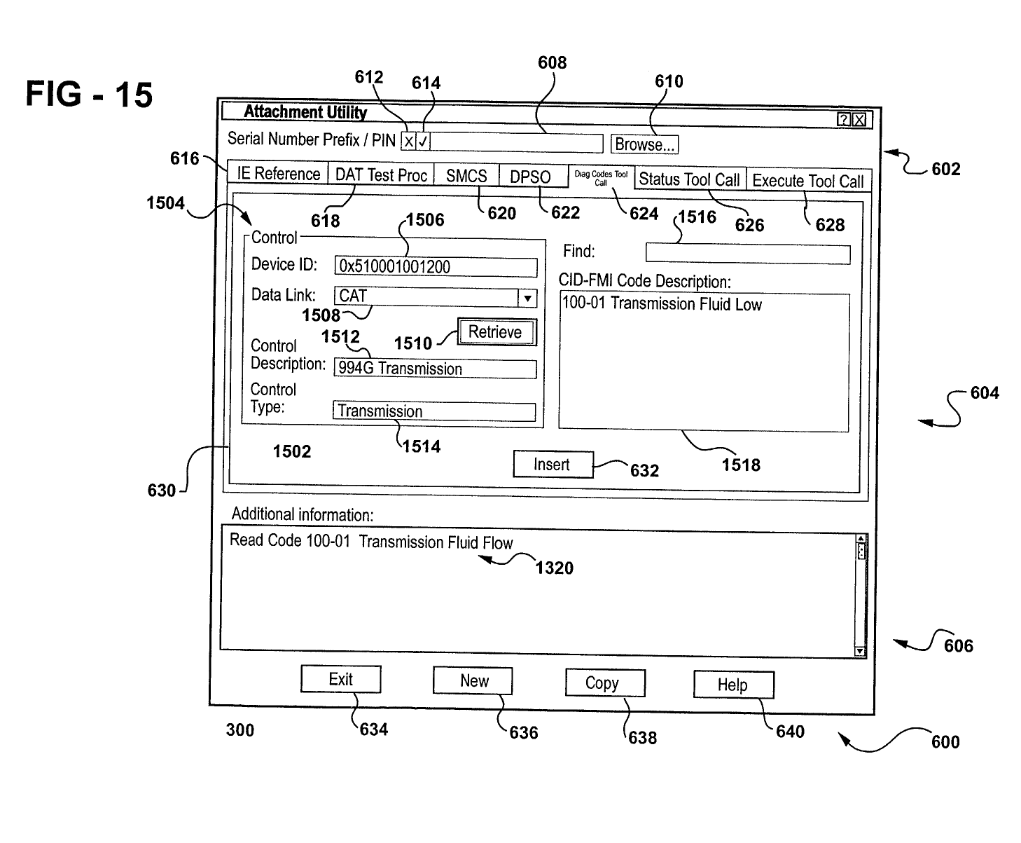

With reference to FIG. 15, upon user selection of the Diag Codes Tool Call Tab 624, a Diag Codes Tool Call Panel 1502 is displayed in the Attachment Information Panel 630. The Diag Codes Tool Call Panel 1502 allows the user to create link to an Electronic Technician (not shown). The Electronic Technician is a computer software program for communication with electronic controls on work machines.

The Diag Codes Tool Call Panel 1502 includes a Control Section 1504. The Control Section 1504 includes a Device ID Text Box 1506, a Data Link Drop Down List 1508, a Retrieve Button 1510, a read-only Control Description Text Box 1512, and a read-only Control Type Text Box 1514. The Diag Codes Tool Call Panel 1502 further includes a Find Text Field 1516 and a CID-FMI Code Description List 1518.

Upon initialization of the Diag Codes Tool Call Panel 1502, the Device ID Text Box 1506, the Control Description Text Box 1512, and CID-FMI Code Description List 1518 are initialized to blank fields. The Data Link Drop Down List 1508 is populated with all available data links.

The author must enter a Device ID in the Device ID Text Box 1506 and select a data link in he Data Link Drop Down List 1508. The Electronic Technician returns to the Attachment Utility 110, the Control Description, Control Type and CID-FMI Code Descriptions. The Find Text Field 1516 is dynamically linked to the CID-FMI Code Description List 1518.

When the Insert Button 632 is actuated, a link 1520 to the selected diagnostic code is inserted into the Additional Information Text Box 606. As described above, the user can add additional descriptive text to the link 1520 in the Additional Information Text Box 606.

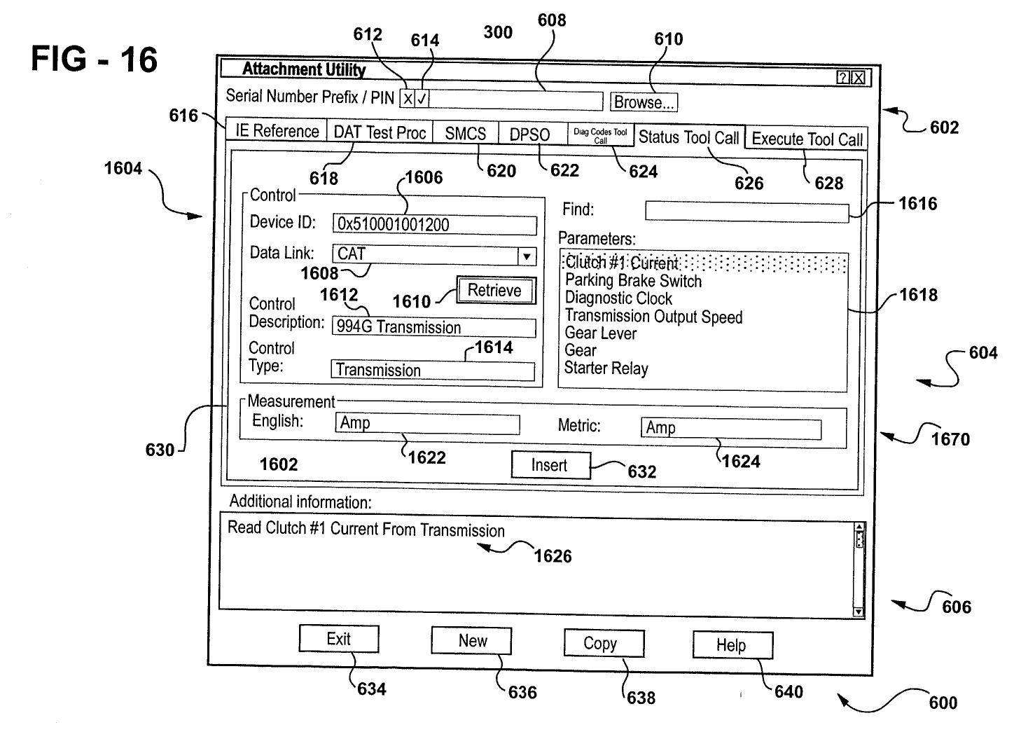

With reference to FIG. 16, upon user selection of the Status Tool Call Tab 626, a Status Tool Call Panel 1602 is displayed in the Attachment Information Panel 630. The Status Tool Call Panel 1502 is used to obtain measurements on a given control type from the Electronic Technician System.

The Status Tool Call Panel 1602 includes a Control Section 1604. The Control Section 1604 includes a Device ID Text Box 1606, a Data Link Drop Down List 1608, a Retrieve Button 1610, a read-only Control Description Text Box 1612, and a read-only Control Type Text Box 1614. The Status Tool Call Panel 1602 further includes a Find Text Field 1616 and a Parameters List 1618.

Upon initialization of the Status Tool Call Panel 1602, the Device ID Text Box 1606, the Control Description Text Box 1612, and Parameters List 1618 are initialized to blank fields. The Data Link Drop Down List 1608 is populated with all available data links. The author fills in the Device ID Text Box 1606, activating the Retrieve Button 1610. Upon actuation of the Retrieve Button 1610, the Electronic Technician returns to the Attachment Utility 110, the Control Description and the Control Type which are placed in the appropriate fields.

The Electronic Technician also returns data for the Parameters List 1618. The Find Text Field 1616 is dynamically linked to the Parameters List 1618.

The Status Tool Call Panel 1602 further includes a Measurements Section 1620 with a read-only English Text Field 1622 and a read-only Metric Text Field 1624. Upon user selection of a parameter in the Parameters List 1618, the appropriate unit of measurement is placed in the Text Fields 1622, 1624.

When the Insert Button 632 is actuated, a link 1626 to the information is inserted into the Additional Information Text Box 606. As described above, the user can add additional descriptive text to the link 1626 in the Additional Information Text Box 606.

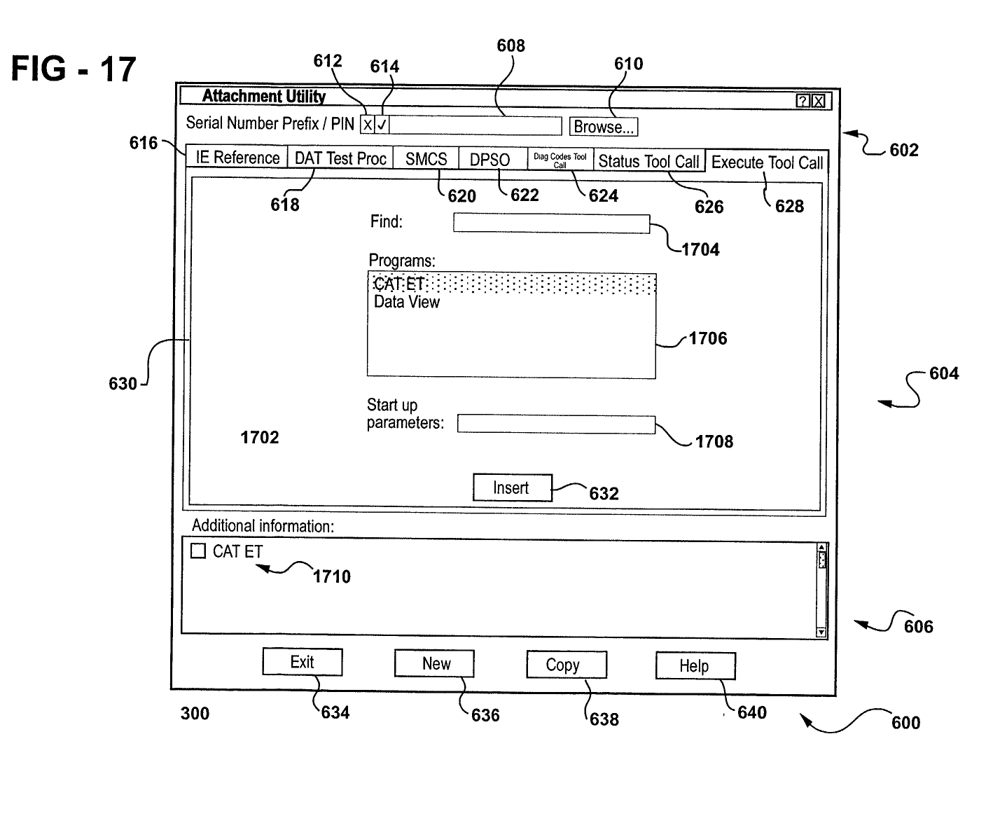

With reference to FIG. 17, upon user selection of the Execute Tool Calls Tab 628, an Execute Tool Calls Panel 1702 is displayed in the Attachment Information Panel 630. The Status Tool Call Panel 1702 is used to create a link to selected programs, for example, the Electronic Technician Program. The Execute Tool Calls Tab 628 includes a Find Text Box 1704, a Programs List 1706 and a Start-Up Parameters Text Box 1708. The Find Text Box 1704 is dynamically linked to the Programs List 1706. The user enters any start up parameters the selected program needs in the Start-Up Parameters Text Box 1708.

When the insert button 632 is actuated, a link 1710 to the selected program is inserted into the Additional Information Text Box 606. As described above, the user can add additional descriptive text to the link 1710 in the Additional Information Text Box 606.

Once a link has been selected and inserted in the Attachment Tabbed Window Pane 604, a link appears in the Additional Information Text Box 606. The Additional Information Text Box 606 is a representation of what will be seen on the delivery side, e.g., in the Diagnostic Delivery System 120 and the Service Advisor 124. The user may type and edit descriptive text of the link.

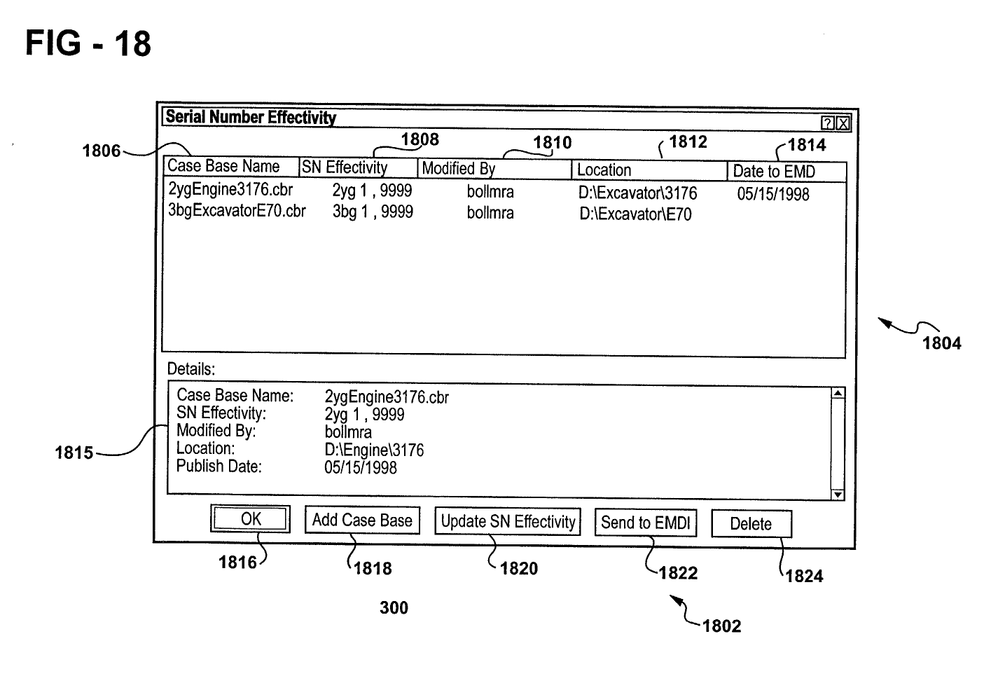

With reference to FIG. 18, upon actuation of the OK button 508 in the Main Utility menu 500 with the Serial Number Effectivity//Send to EMD radio button 504 actuated, a Serial Number Effectivity Screen 1802 is displayed. The Serial Number Effectivity Screen 1802 is used by the author to view case bases which have been given serial number effectively and to view if and when the case bases were sent to the electronic media delivery system 116. Effectivity is defined as the list of products, identified by the serial number prefix and optional serial number range to which a case base applies.

The Serial Number Effectivity Screen 1802 includes a Case Base List 1804 with a Case Base Name Column 1806, an SN Effectivity Column 1808, a Modified By Column 1810, a Location Column 1812, and a Date to EMD Column 1814.

The Serial Number Effectivity Screen 1802 further includes a Details Text Box 1815 for displaying detailed information regarding a selected case base.

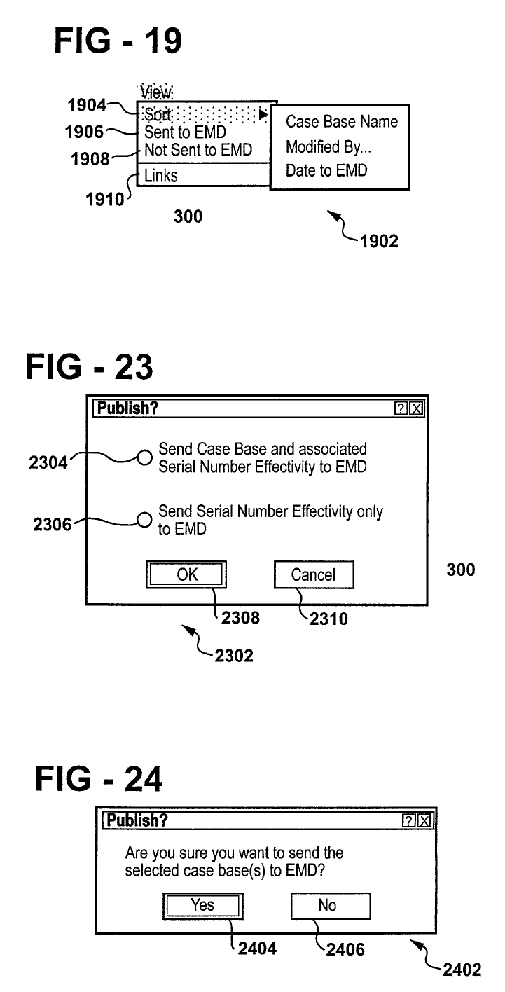

With reference to FIG. 19, a View Menu 1902 is accessible by right clicking in the Serial Number Effectively Screen 1802.

The View Menu 1902 includes a Sort Menu 1904. The Sort Menu Option 1904 allows the user to select the field (Case Base Name, Modified By, Date to EMD) by which the case bases in the Case Base List 1804 are sorted. The View Menu 1902 also includes a Sent to EMD Menu Item 1906 and a Not Sent To EMD Menu Item 1908 for selecting which case bases are displayed in the Case Base List 1804. Either or both Menu Items 1906, 1908 may be selected.

The View Menu 1902 further includes a Link Menu Item 1910.

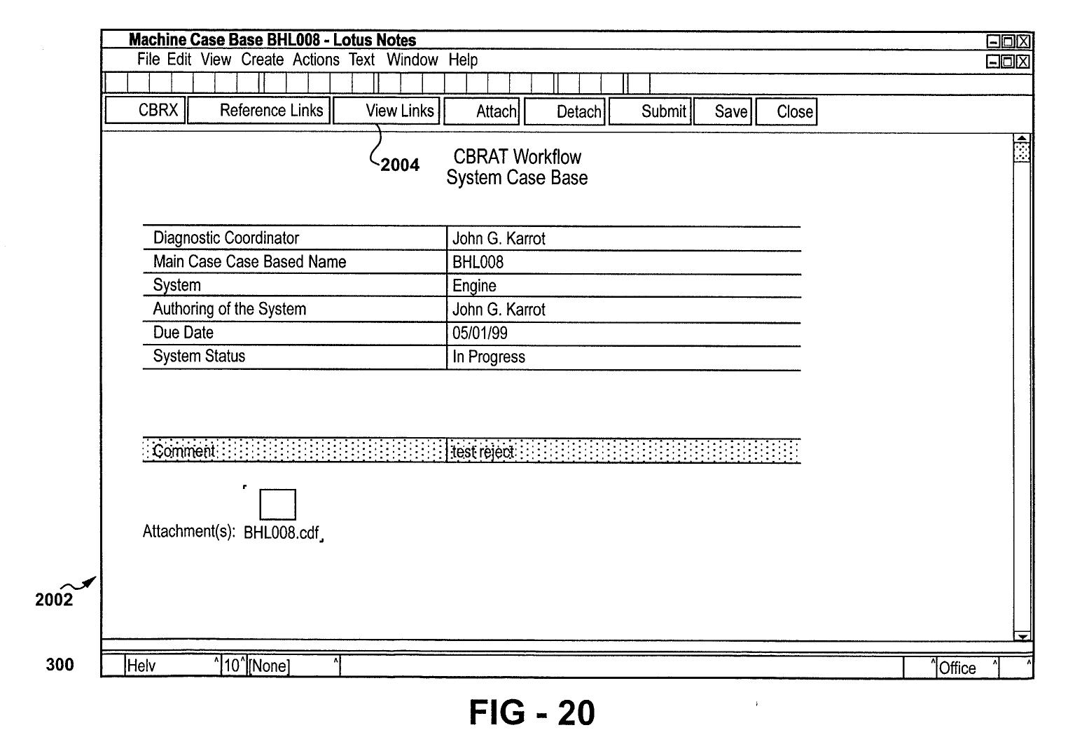

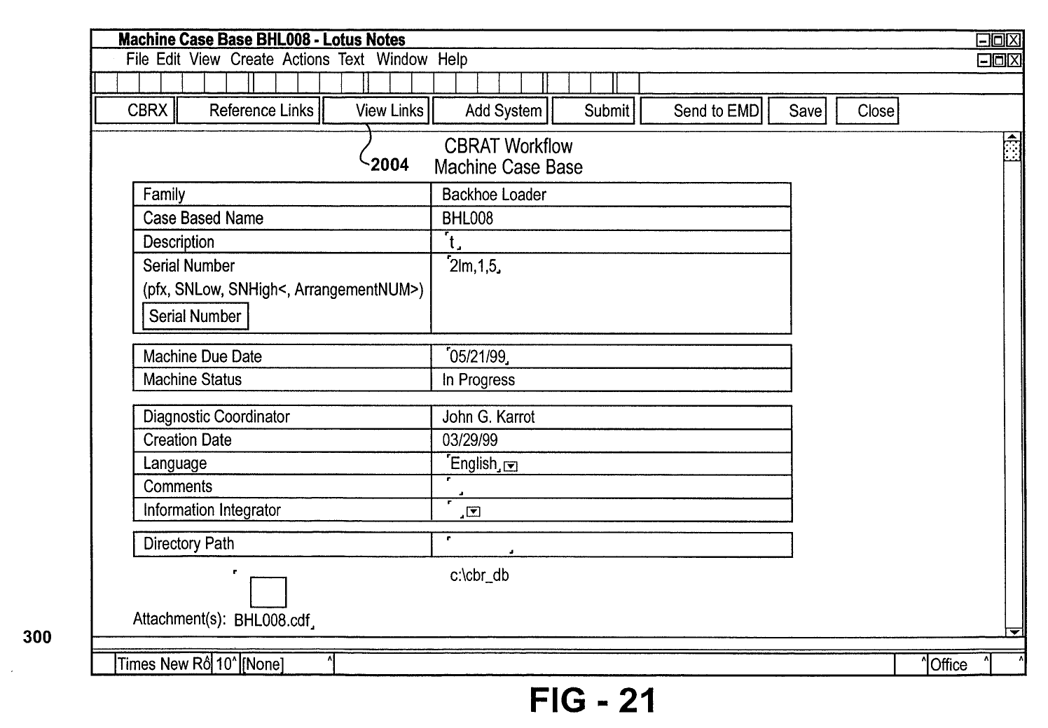

With reference to FIG. 20, selection of the Link Menu Item 1910 closes the View Menu 1902 and displays a Case View Screen 2002, preferably implemented as a Lotus Notes Database. Link data may be displayed either as System Case Bases (as shown in FIG. 20) or as Machine Case Bases, as shown In FIG. 21.

The System Case View Screen 2002 includes a View Links Button 2004.

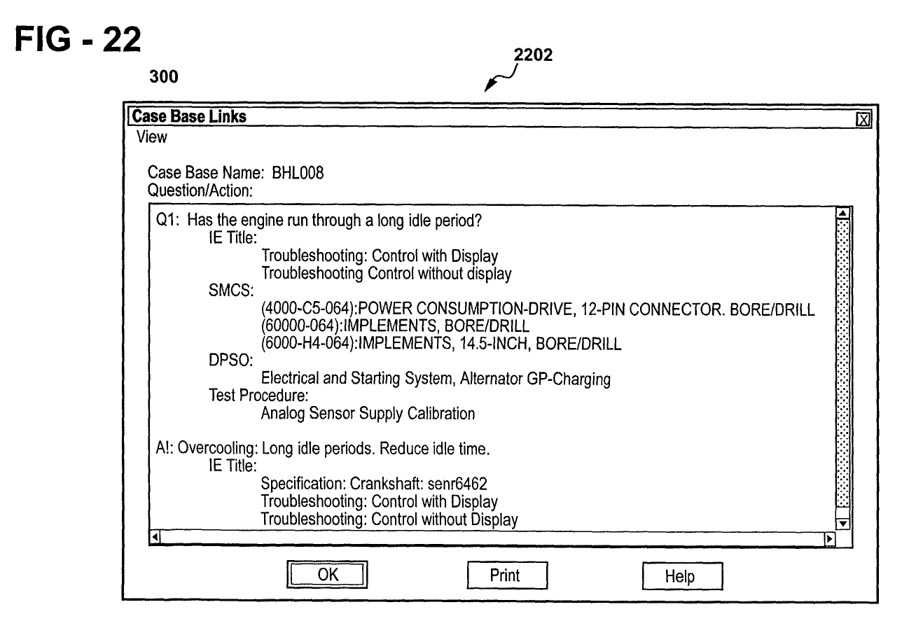

With reference to FIG. 22, actuation of the View Links Button 2004 displays a Case Base Links Dialog 2202 containing detailed information on the links contained in the selected case base. Preferably, links may be viewed in four formats:

1. Question/Action: All Questions and Answers are listed with related links following each Question/Answer in the following order: IE References, SMCS, Product Structure, Test Procedure, Diagnostic Code Tool Cool, Status Tool Call, and Execute Tool Call.

2. IE Links: All Questions and Answers are listed with only the IE Links following.

3. SMCS Links: All Questions and Answers are listed with only the SMCS Links following.

4. DPSO Links: All Questions and Answers are listed with only the DPSO Links following.

Returning to FIG. 18, the Serial Number Effectivity Screen 1802 includes an OK Button 1816, an Add Case Base Button 1818, an Update Serial Effectivity Button 1820, a Send to EMD Button 1822, and a Delete Button 1824.

Actuation of the OK Button 1816 dismisses the Serial Number Effectivity Screen 1802.

With reference to FIG. 23, upon actuation of the Send to EMD button 1822 on the Serial Number Effectivity Screen 1802, a Serial Number Publish Dialog 2302 is displayed. The Serial Number Publish Dialog 2302 includes a Send Case Base and Serial Number to EMD Radio Button 2304 and a Send Serial Number Only Radio Button 2306. The Send Case Base and Serial Number to EMD Radio Button 2304 and a Send Serial Number Only Radio Button 2306 are mutually exclusive.

The Serial Number Publish Dialog 2302 includes an OK Button 2308 and a Cancel Button 2310.

With reference to FIG. 24, with actuation of the OK Button 2308 with either the Send Case Base and Serial Number to EMD Radio Button 2304 and a Send Serial Number Only Radio Button 2306 selected, a Publish Confirmation Dialog 2402 is displayed. The Publish Confirmation Dialog 2402 includes an Yes Button 2404 and a No Button 2406. The user may select either to confirm or cancel publication of the case base.

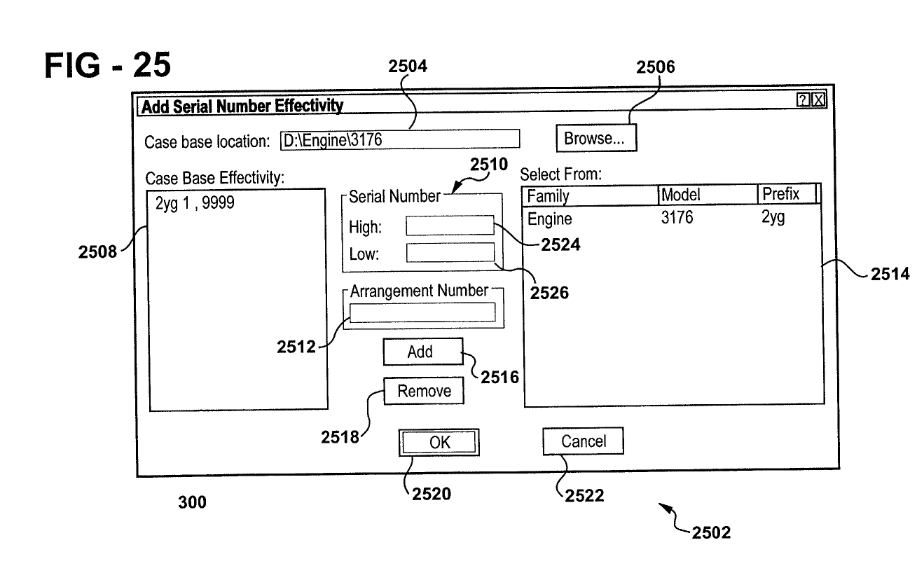

With reference to FIGS. 18 and 25, with user actuation of the Add Case Base Button 1818, an Add Effectivity Dialog 2502 allows the user to add serial number effectivity to the selected case base. The Add Effectivity Dialog 2502 includes a Case Base Location Text Box 2504, a Browse Button 2506, a Case Base Effectivity List 2508, a Serial Number Range Section 2510, an Arrangement Number Text Box 2512, a Select List 2514, an Add Button 2516, a Remove Button 2518, an OK Button 2520, and a Cancel Button 2522.

First, the user must set the location of the case base. This may be done by entering the location of the case base directly into the Case Base Location Text Box 2504 or selecting the case base through a Browse Dialog (not shown) through actuation of the Browse Button 2506. With the case base selected, the available family names of machines or systems are listed in the Select List 2514. The user must select a Family in the Select List 2514.

The Serial Number Range Section 2510 includes a High Text Box 2524 and a Low Text Box 2526. Selection of a Family in the Select List 2514 defaults the High Text Box 2524 and the Low Text Box 2526 to 99999 and 1, respectively. The user can change the default values. The user can also add an arrangement number in the Arrangement Number Text Box 2512, but this is optional.

When the information is correct, the user may actuate the Add Button 2516 to add an effectivity date to the Case Base Effectivity List 2508. The Case Base Effectivity List 2508 displays all effectivity dates for the selected case base. The user may delete effectivity dates for the current case base by actuation the Remove Button 2518 while an effectivity date is highlighted.

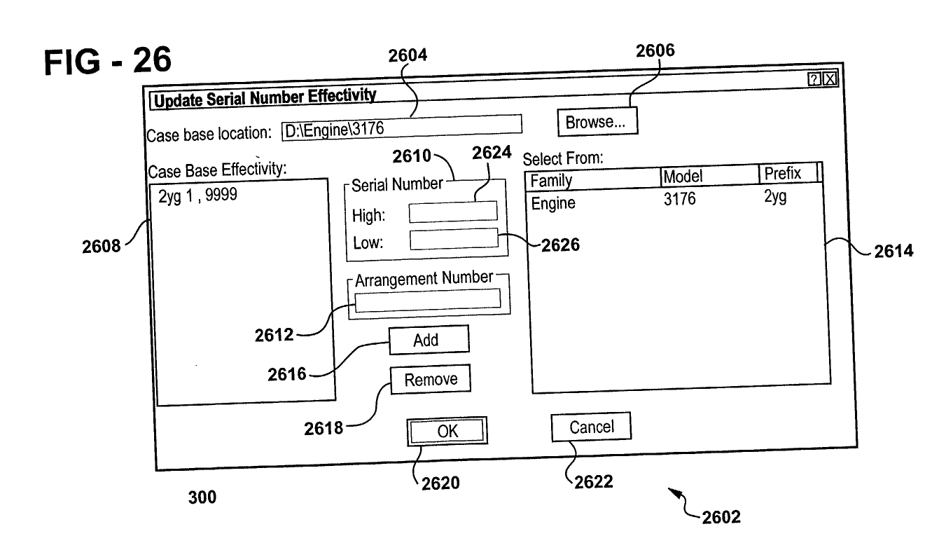

With reference to FIGS. 18 and 26, with actuation of the Update SN Effectivity Button 1820, an Update Effectivity Dialog 2602 allows the user to update serial number effectivity to the selected case base. The Update Effectivity Dialog 2602 includes a Case Base Location Text Box 2604, a Browse Button 2606, a Case Base Effectivity List 2608, a Serial Number Range Section 2610, an Arrangement Number Text Box 2612, a Select List 2614, an Add Button 2616, a Remove Button 2618, an OK Button 2620, and a Cancel Button 2622. The Serial Number Range Section 2610 includes a High Text Box 2624 and a Low Text Box 2626.

The Update Effectivity Dialog 2602 is used to change or add the effectivity on case base that is already located in the serial number effectivity window. Operation of the Update Effectivity Dialog 2602 is similar to that of the Add Effectivity Dialog 2502. To change the effectivity on a prefix, the user would first remove a selection from the Case Base Effectivity List 2608. The user would then locate the prefix in the Select List 2614 and assign the correct effectivity and Arrangement Number. The Update Effectivity Date Dialog 2602 can also be used to add additional prefixes to the case base.

Returning to FIG. 18, upon actuation of the Delete Button 1824, a Confirmation Dialog (not shown) is used to confirm deletion of a case base.

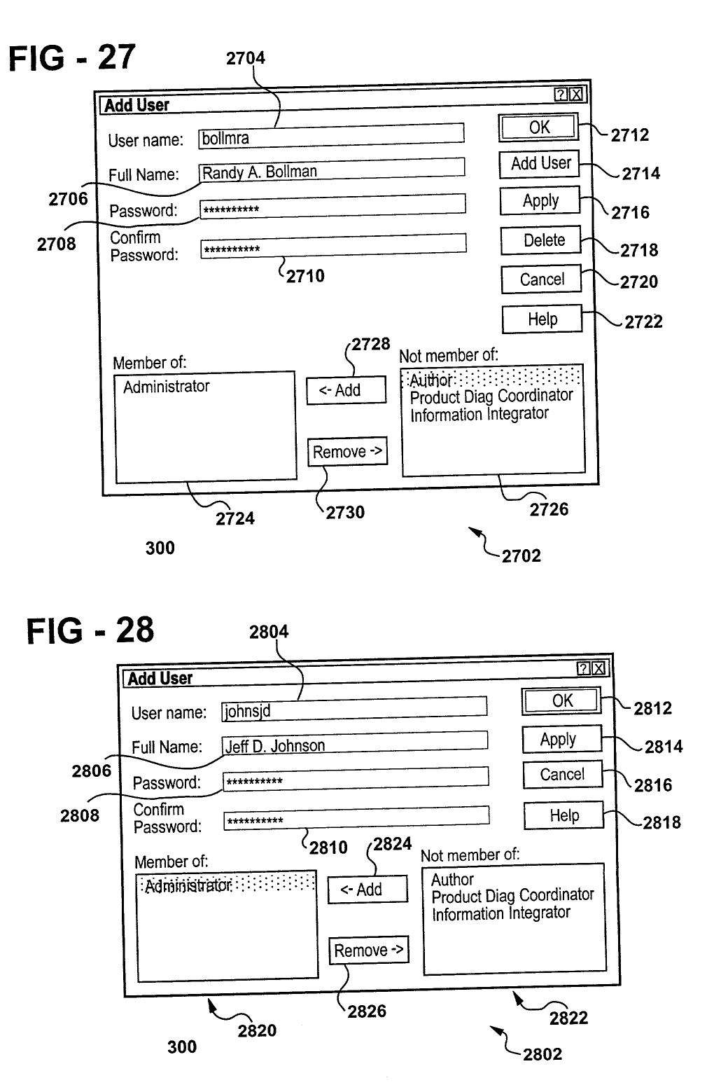

With reference to FIG. 27, upon actuation of the OK button 508 in the Main Utility menu 500 with the User Administration radio button 506 actuated a User Properties Screen 2702 is displayed. The User Properties Screen 2702 includes a User Name Drop Down List 2704, a Full Name Text Box 2706, a Password Text Box 2708, a Password Confirmation Text Box 2708, an OK Button 2712, an Add User Button 2714, an Apply Button 2716, a Delete Button 2718, a Cancel Button 2720, and a Help Button 2722. The User Properties Screen 2702 further includes a Member List 2724, a Not Member of List 2726, an Add Button 2728, and a Remove Button 2730.

The User Properties Screen 2702 is used to control the privileges of users. To update user information, a user is selected from the User Name Drop Down List 2704. The user's information can be modified, i.e., password and member status. To update the information, the Apply Button 2716 is actuated.

The Member List 2724 and the Not Member List 2726 define the user's rights within the system 100. The Add Button 2728 and the Remove Button 2730 are used to add and remove rights to the user.

Actuation of the Delete Button 2718 displays a Confirmation Dialog (not shown) to confirm deletion of a user. Actuation of the Cancel Button 2720 dismisses the User Properties Dialog 2702.

With reference to FIG. 28, upon actuation of the Add User Button 2714, an Add User Dialog 2802 is displayed. The Add User Dialog 2802 includes a User Names Text Box 2804, a Full Name Text Box 2806, a Password Text Box 2808, a Password Confirmation Text Box 2810, an OK Button 2812, an Apply Button 2814, a Cancel Button 2816, and a Help Button 2818. The Add User Dialog 2802 further includes a Member List 2820, a Not Member List 2822, an Add Button 2824, and a Remove Button 2826. Operation of the Add User Dialog 2802 is similar to the User Properties Dialog 2702. After the user's information is entered, the OK Button 2812 or the Apply Button 2814 is actuated. The OK Button 2812 dismisses the Add User Dialog 2802 after the information has been added. The Apply Button 2814 can be used to enter multiple users.

Of course, various modifications of this invention would come within the scope of the invention.

### INDUSTRIAL APPLICABILITY

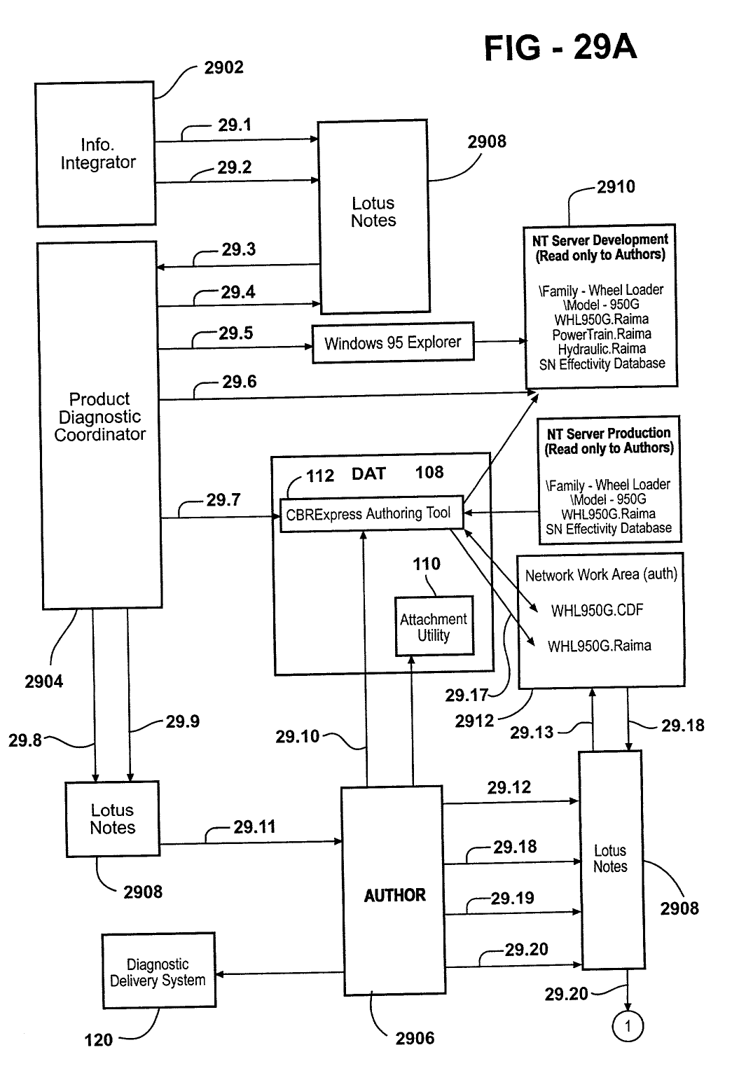

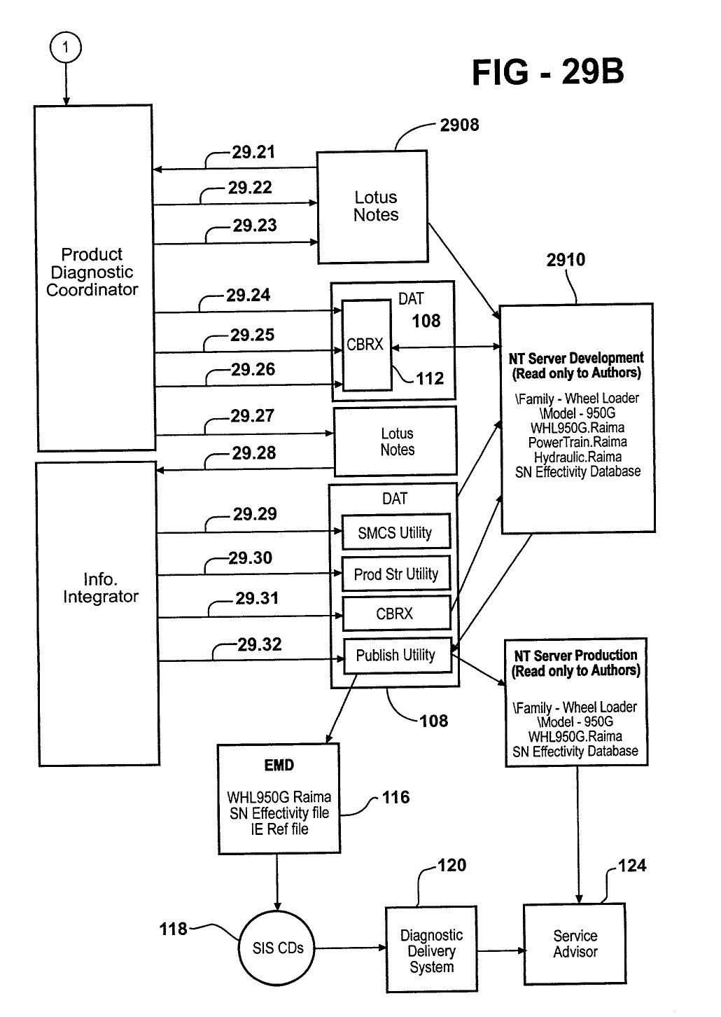

With reference to FIGS. 29A-29B, in practice there are three users of the computer based system: an Information Integrator or “II” (2902), a Product Diagnostic Coordinated or “PDC” (2904), and an Author or “A” (2906). Preferably, coordination of the case base through the authoring process is accomplished through a Lotus Notes database 2908.

For Case Base Authoring Requests that are received, the II 2902 will initially create or modify the case base outline or “CBO” 29.1 and initiate a work instance to the PDC 2904 to create or modify the case base.

The PDC 2904 will receive the request from the II 2902 that a case base needs to be created of modified 29.3. If a new case base needs to be created, the PDC 2904 will begin by reading the CBO to understand how the case is to be structured into a machine and systems case bases 29.4.

Next the PDC 2904 will create the initial machine case base assignment and also create an assignment for each of the system case bases that need to be authored. The Q & A's and the initial empty case bases are stored in a file in “CDF” format.

Once the machine case base is created, the PDC 2904 will assign the Serial Number Effectivity to the machine case base 29.8, attach the CDF file 29.9, and assign authors to write each of the system case bases 29.10.

The Author 2906 receives the assignment from the PDC 2904 to author a system case base for a given machine 29.11. The Author 2906 detaches the CDF file 29.12 to a local workstation and imports the data into a raima database 29.13. Next, the Author 2906 uses the Case Base Authoring Tool 112 to author questions and actions that will lead service technicians to the root cause of possible problems that with the work machine 128. The Author uses the Attachment Utility 110 to embed links to the Service Information System 102A documents within the Questions and Actions detail information so the service technicians can reference specific technical information while trouble shooting a problem on a work machine 128.

One of the actions, the Author may write is a Diagnostic Code Procedure or a System Functional Test. In these cases, the Author will use the Attachment Utility 110 to create a link to the specific test procedure, the Author wants the end user to run. When the Service Technician is running through the case base on the Diagnostic Advisor 120, the attachments will be displayed as hyper-links in an additional information box on the Question Detail and Action Detail screens. When the hyper-links are accessed, the System Function Test or Diagnostic Code Procedure will be automatically started.

Electronic Technician or ET links may also be embedded into question and actions through the use of the Attachment Utility 110. ET links will be attached to questions to aid the Service Technician in answering the questions. For instance, the question may read “What is the oil temperature?”. The user could then click on the ET attachment that will automatically read the oil temperature from the machine. Comparatively, an action may state “Check for any logged or active codes on the machine.” The author could embed an ET link that would enable the user to click on the ET link and automatically read the diagnostic codes from the ET.

Once the Author has tested the case base using the Case Base Authoring Tool 112, the Author exports the modified CDF file to a network work area 2912 (step 29.17) and attaches the CDF file to the Lotus Notes database 2908 (step 29.18). Then, the Author 2906 indicates any Serial Number Effectivity that should be used for the system case base 29.19 and sends the case back to the PDC 2904 (step 29.20).

After the Author 2906 sends the case back to the PDC 2904, the PDC 2904 is notified 29.21. The PDC 2904 detaches the CDF file to the server 2910 (step 29.22) and reads the case base outline 29.23. The CDF file is then imported into the case base 29.24. The PDC 2904 collects all the completed case bases and combines them into one machine case base 29.25. After the PDC 2904 has tested the machine case base 29.26 and is satisfied that all the content is correct, the PDC 2904 will assign the case base to the II 2902 (step 29.27) or publishes the case base via EMD 116.

The II 2904 assigns DPSO and SMCS to actions and questions 29.30, 29.31. The II 2904 then exports the case to a CDF file 29.32 and publishes the case 29.32 via the EMD 116.

Other aspects, objects and advantages of this invention can be obtained from a study of the drawings, the disclosure and the appended claims.

1. A computer based method for authoring case bases related to a work machine, the case bases being comprised of diagnostic information and processes related to the work machine, including the steps of:
as a function of input from an author, authoring a case base;
providing an external source containing service information related to the work machine; and,
as a function of input from the author, providing a link within the case base to related information contained in the external source.

2. A computer based method, as set forth in claim 1, including the step of authoring at least one system functional test, as a function of input from the author.

3. A computer based method, as set forth in claim 1, including the step of authoring at least one diagnostic procedure, as a function of input from the author.

4. A computer based method, as set forth in claim 1, including the step of delivering the case base electronically for publication.

5. A computer based method, as set forth in claim 4, including the step of publishing the case base in at least one of the following forms: paper, computer readable media, and on-line.

6. A computer based method, as set forth in claim 1, including the step of delivering the case base to a diagnostic delivery system.

7. A computer based method, as set forth in claim 6, including the step of receiving feedback from the diagnostic delivery system and wherein the feedback is incorporated into future case bases.

8. A computer based method, as set forth in claim 1, including the step of delivering the case base to a service advisor.

9. A computer based method, as set forth in claim 8, including the step of receiving feedback from the service advisor and wherein the feedback is incorporated into future case bases.

10. A computer based method for authoring case bases related to a work machine, the case bases being comprised of diagnostic information and processes related to the work machine, including the steps of:
as a function of input from an author, authoring a case base;
providing an external source containing service information related to the work machine;
as a function of input from the author, providing a link within the case base to related information contained in the external source; and,
providing a graphical user interface for operation by the author.

11. A computer based method, as set forth in claim 10, including the step of providing a main utility menu.

12. A computer based method, as set forth in claim 10, including the step of providing an attachment utility screen for operation by the author to create the link.

13. A computer based method, as set forth in claim 12, including the step of providing a tabbed window pane having a plurality of tabs, wherein selection of one of the tabs results in a respective one of a plurality of panels being displayed in the tabbed window pane.

14. A computer based method, as set forth in claim 13, wherein each of the plurality of tabs corresponds to one of a plurality of attachment types.

15. A computer based method, as set forth in claim 14, including the step of providing an insert button and an additional information text box on the attachment utility screen.

16. A computer based method, as set forth in claim 15, including the step of inserting the link into the case base in response to actuation of the insert button by the author.

17. A computer based method, as set forth in claim 16, including the step of displaying the link in the additional information text box.

18. A computer based method for authoring case bases related to a work machine, the case bases being comprised of diagnostic information and processes related to the work machine, including the steps of:
as a function of input from an author, authoring a case base;
authoring at least one of a system functional test and a diagnostic procedure, as a function of input from the author providing an external source containing service information related to the work machine;
as a function of input from the author, providing a link within the case base to related information contained in the external source;
delivering the case base electronically for publication;
delivering the case base to one of a diagnostic delivery system and a service advisor; and,
receiving feedback from the one of a diagnostic delivery system and a service advisor and wherein the feedback is incorporated into future case bases.

19. A computer based system for authoring case bases related to a work machine, comprising:
an external source containing service information related to the work machine; and a diagnostic reasoning authoring tool for authoring a case base, the diagnostic reasoning authoring tool containing an attachment utility for providing a link, based on input from an author, to related information in the external source.

20. A computer based system, as set forth in claim 19, wherein the diagnostic reasoning authoring tool includes a diagnostic authoring tool for authoring at least one system functional test, as a function of input from the author.

21. A computer based system, as set forth in claim 19, wherein the diagnostic reasoning authoring tool includes a diagnostic authoring tool for authoring at least one diagnostic procedure, as a function of input from the author.

22. A computer based system, as set forth in claim 19, wherein the diagnostic reasoning authoring tool includes means for delivering the case base electronically for publication.

23. A computer based system, as set forth in claim 19, the diagnostic reasoning authoring tool being adapted to publish the case base in at least one of the following forms: paper, computer readable media, and on-line.

24. A computer based system, as set forth in claim 19, the diagnostic reasoning authoring tool being adapted to deliver the case base to a diagnostic delivery system.

25. A computer based system, as set forth in claim 24, the diagnostic reasoning authoring tool being adapted to receive feedback from the diagnostic delivery system and incorporate the feedback into future case bases, as a function of input from the author.

26. A computer based system, as set forth in claim 19, the diagnostic reasoning authoring tool being adapted to deliver the case base to a service advisor.

27. A computer based system, as set forth in claim 26, the diagnostic reasoning authoring tool being adapted to receive feedback from the service advisor and incorporate the feedback into future case bases, as a function of input from the author.

28. A computer based system for authoring case bases related to a work machine, comprising:
an external source containing service information related to the work machine;
a diagnostic reasoning authoring tool for authoring a case base, the diagnostic reasoning authoring tool containing an attachment utility for providing a link, based on input from an author, to related information in the external source; and
a graphical user interface for operation by the author.

29. A computer based system, as set forth in claim 28, including an attachment utility screen for operation by the author to create the link.

30. A computer based system, as set forth in claim 29, including a tabbed window pane having a plurality of tabs, wherein selection of one of the tabs results in a respective one of a plurality of panels being displayed in the tabbed window pane.

31. A computer based system, as set forth in claim 30, wherein each of the plurality of tabs corresponds to one of a plurality of attachment types.

32. A computer based system, as set forth in claim 31, including an insert button and an additional information text box on the attachment utility screen, wherein the link into the case base in response to actuation of the insert button by the author and is displayed in the additional information text box.

33. A computer based system for authoring case bases related to a work machine, comprising:
an external source containing service information related to the work machine;
a diagnostic reasoning authoring tool for authoring a case base, the diagnostic reasoning authoring tool containing an attachment utility for providing a link, based on input from an author, to related information in the external source, the diagnostic reasoning authoring tool also includes a diagnostic authoring tool for authoring at least one system functional test, as a function of input from the author, wherein the diagnostic reasoning authoring tool further includes a diagnostic authoring tool for authoring at least one diagnostic procedure, as a function of input from the author;
means for delivering the case base electronically for publication; and,
means for delivering the case base to one of a diagnostic delivery system and a service advisor and for receiving feedback from the one of the diagnostic delivery system and the service advisor and incorporating the feedback into future case bases, as a function of input from the author.

34. A computer program product for authoring case bases related to a work machine, the case bases being comprised of a process for diagnosing and performing operations relative to the work machine, the computer program product comprising a computer usable storage medium having computer readable program code means embodied in the medium, the computer readable program code means comprising:
computer readable program code means for authoring a case base, as a function of input from an author;
computer readable program code means for providing a external source containing service information related to the work machine; and,
computer readable program code means for providing a link within the case base to related information contained in the external source, as a function of input from the author.

35. A computer program product, as set forth in claim 34, including computer readable program code for authoring at least one system functional test, as a function of input from the author.

36. A computer program product, as set forth in claim 34, including computer readable program code for authoring at least one diagnostic procedure, as a function of input from the author.

37. A computer program product, as set forth in claim 34, including computer readable program code for delivering the case base electronically for publication.

38. A computer program product, as set forth in claim 37, including computer readable program code for publishing the case base in at least one of the following forms: paper, computer readable media, and on-line.

39. A computer program product, as set forth in claim 34, including computer readable program code for delivering the case base to a diagnostic delivery system.

40. A computer program product, as set forth in claim 34, including computer readable program code for receiving feedback from the diagnostic delivery system and wherein the feedback is incorporated into future case bases.

41. A computer program product, as set forth in claim 34, including computer readable program code for delivering the case base to a service advisor.

42. A computer program product, as set forth in claim 34, including computer readable program code for receiving feedback from the service advisor and wherein the feedback is incorporated into future case bases.
